(19) United States
(12) Patent Application Publication
(10) Pub. No.: US 2024/0066681 A1
(43) Pub. Date: Feb. 29, 2024

(54) MULTI-PURPOSE SCREWDRIVER AND BIT HOLDER TOOL

(71) Applicant: Rojoeyl Aquino, East Elmhurst, NY (US)

(72) Inventor: Rojoeyl Aquino, East Elmhurst, NY (US)

(21) Appl. No.: 18/502,793

(22) Filed: Nov. 6, 2023

(51) Int. Cl. B25G 1/08; B25B 15/02; B25B 23/00; B25G 1/10; G01B 3/00; G01B 3/04

(52) U.S. Cl. CPC B25G 1/085; B25B 15/02; B25B 23/0035; B25G 1/102; G01B 3/004; G01B 3/04; B25B 27/0071

(57) ABSTRACT

A multipurpose screwdriver and bit holder tool, comprising an outer housing defining a longitudinal axis having channels on the outer periphery for storage of one or more screw bits, ensuring secure retention and easy accessibility; an ergonomic anti-slip handle, ensuring a comfortable grip and convenient tool access with an attachment for difficult to access areas; a Slide-in and slide-out screw bit design in the channels in the outer periphery of the tool, allowing for quick tool interchange, wherein the screw-bits retained in place in the channels; and an wrench cap equipped with a magnetic slide-lock mechanism for secure screw bit storage. The tool further comprises hex Sockets, wingnut too, wire-bender tool, bubble leveler, spoke wrench, rulers, double sided screw bits in the internal housing. The screwdriver and bit holder tool can be used with an attachment having more tools.

### TECHNICAL FIELD

The present invention related to screwdriver and more particularly to a holder that can be use as tool and for storing multiple multipurpose different size interchangeable screw bits, spoke wrenches, file, bubble level, attachment and extensions.

### BACKGROUND

The following description includes information that may be useful in understanding the present invention. It is not an admission that any of the information provided herein is prior art or relevant to the presently claimed invention, or that any publication specifically or implicitly referenced is prior art.

The variety of screwdriver bit sizes and types which are required for most purposes makes it practical and economical to utilize a single screwdriver handle having interchangeable bits.

Various designs are in use wherein a single screwdriver handle can be fitted with multiple interchangeable bits where such bits can be stored in the handle, thereby reducing the number and expense of screwdriver tools required to drive the various sizes and head configurations of screws.

In the most common of these designs, the multiple bits are stored loosely in a hollow handle. To select a particular bit, an end cap on the handle is unscrewed, all the bits are removed from the handle, the desired bit is selected and secured in a chuck, the remaining bits are returned to the handle and the end cap is replaced. The problem with this design is that the bits are frequently dropped and misplaced, and on some models the handle itself is not well suited for the manual act of driving the screw as the end cap may become loosened while the handle is being turned.

Various handle configurations have been suggested which involve storing the multiple bits securely in the handle and utilizing some mechanism to transfer the selected bit to the chuck. Most of these are too cumbersome to use and expensive to manufacture to have achieved acceptance. An example is the multi-chambered tool holder described in U.S. Pat. No. 3,405,749 issued Oct. 15, 1968, to Butler which utilizes an arrangement which requires manipulating bits to fall out of or back into the handle through a rotatable disc and a cone-shaped end piece before or after being secured in the chuck end.

U.S. Ser. No. 11/148,276B2 introduces a screwdriver that efficiently stores multiple bits within a storage device, making them readily selectable for retrieval and use. The storage device is equipped with at least one cartridge that has a cavity for accommodating one or more bits. Additionally, a receiver is designed to contain at least one cell for receiving the cartridge, and a passageway runs longitudinally along the center of the receiver, ultimately leading to an opening on the receiver's external surface.

U.S. Ser. No. 10/442,074B2 titled “Locking mechanism” describes a locking mechanism for securing for use an item selected and retrieved from an opening in a storage device configured for storing one or more items, includes a tubular shaft extending from the opening in the storage device for receiving the selected item from the storage device. A passageway is defined within the tubular shaft for facilitating travel of the selected item from the opening in the storage device to an end of the shaft opposing the opening. At least one locking block and stop is configured for securing the selected item at the end of the tubular shaft opposing the opening.

U.S. Pat. No. 6,435,065B2 titled “Tool handle for storing bits” describes bit-storing tool handle is provided that includes a surface of the handle defining a channel adapted to retain the bit, and a fulcrum point contained within the channel for rotating the retained bit out of the channel. The bit-storing tool handle may alternatively include a plurality of channels adapted to retain the bits such that the longitudinal axis of the retained bits are co-linear to the longitudinal axis of the handle and a fulcrum point within each of the channels that promotes the manual rotation of each of the bits about a cooperating fulcrum point so that upon such rotation, the bits extend radially from the longitudinal axis of the handle. The channels include an opening dimensioned and configured to allow the finger of a person to insert under a first end of the bit thereby facilitating the removal of the bit from the channel when an excessive amount of force is required to pivot the bit due to cold weather or similar conditions. The opening provides an alternative to the fulcrum point for the removal of the bit from the channel.

U.S. Pat. No. 6,327,942B1 titled “Multiple bit driver” describes a driver provided with storage for interchangeable bits in the handle portion. The handle portion comprises a generally cylindrical driver body that is aligned along a common longitudinal axis with the shaft. Evenly spaced and outwardly opened grooves span longitudinally along the body for providing channel access to bits, such that one bit is stored in each groove. A bit cap is positioned over the heel end of the driver body and extends at least partially along the length of the driver body to form bit storage chambers. Through apertures in the closed end of the bit cap are spaced to align with the corresponding grooves in the handle body, for inserting and removing bits. A bit gate consisting of a circular disk having a single gate aperture is positioned between the heel of the driver body and the bit cap for selection of a desired bit. A bit selector knob extends longitudinally outward from the bit gate, through the back portion of the bit cap. By turning the bit gate, a user can cause the gate aperture in the bit gate to align longitudinally with any one of the grooves in the handle for replacing or removing bits, or alternatively, the gate aperture may be positioned between grooves effectively locking the bits in their respective bit channels.

US20030079581A1 pertains to a versatile tool that combines a screwdriver and bit holder designed for compatibility with a drill chuck. It comprises a shaft, with one end tailored for easy attachment to a drill chuck and the other end meant for securely holding various tool bits. Additionally, the invention features a housing connected to the shaft, which contains compartments for storing these tool bits in a secure and easily accessible manner. Furthermore, this bit holder can be coupled with a handle, specifically designed to receive it, effectively transforming the combination into a manual screwdriver for added utility and adaptability.

U.S. D535540S1 by Craig Caplan titled “Screwdriver” describes an ornamental design for a screwdriver.

U.S. Pat. No. 7,493,838B2 by Fern Beauchamp titled “multi-bit screwdriver” discloses a multi-bit screwdriver comprises a housing with a bit chuck at the front end and bit assemblies retained within the housing. Each bit assembly has a tool bit at the front end and a contact surface at a back end. An actuator extends from each bit assembly for operative engagement by a user, for movement of the actuator and bit assembly between a forwardly extended in-use configuration whereat the bit assembly is positioned such that the tool bit extends outwardly from the housing, and the contact surface of the bit assembly is disposed in longitudinal force transmitting engagement against an abutment surface to preclude rearward movement of the bit assembly due to substantially longitudinally directed forces transmitted from the tool bit, and a retracted configuration whereat the contact surface of the bit assembly is removed in a lateral direction from the longitudinal force transmitting engagement with the abutment surface.

Consequently, a need still exists for an innovation which will provide an effective solution to the aforementioned problem in the prior art without introducing any new problems in place thereof.

A novel and innovative screwdriver is proposed in the description to store multiple screw bits in order with a screwdriver handle to use those screw bits, allowing users to carry all the necessary tools in one compact and all-in-one multitool.

### SUMMARY OF THE INVENTION

The present invention relates to a screwdriver and bit holder that is use as tool and to store more than twenty-seven different size screw-bits in their dedicated housings or slots or channels in the outer housing.

The screwdriver and bit holder tool is a comprehensive and versatile tool for all the screwing and fastening needs. Its all-in-one design means that a user can carry a wide range of screw bits in a single tool, saving space and making it a convenient addition to the toolkit. The durability of the screw bits, including the solid construction and integrated detent ball, ensures that user can rely on this tool for various tasks, including heavier repairs.

In another embodiment, the screwdriver has different housing or slots or channels to store screw-bits that are ¾″ and 3/16″ in size, spoke wrenches, double ended hex sockets, bubble level and an attachment.

The housing of the screw bit driver holder, which is circular and having channels to carry different types of screw bits in such channels. The screw bits can slide in and slide out and interchanged to the screwdriver handle.

The handle is an ergonomic anti-slip handle with dedicated storage for all your tools, all are visible and accessible in seconds.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates the expanded or exploded view of the screwdriver and bit holder tool with an extension and attachment, in accordance with the embodiment of the current invention.

FIG. 2 illustrates a view of the screwdriver and bit holder tool outer housing without attachment or extension, in accordance with the embodiment of the current invention.

FIG. 3 illustrates the closed view of the screwdriver and bit holder tool with attachment, in accordance with the embodiment of the current invention.

FIG. 4 illustrates the compact view of the screwdriver with attachment, in accordance with the embodiment of the current invention.

FIG. 5 illustrates another exploded view of the screwdriver and bit holder tool, in accordance with the embodiment of the current invention.

FIG. 6 illustrates interim assembly view of the screwdriver and bit holder tool, in accordance with the embodiment of the current invention.

### DETAILED DESCRIPTION OF DRAWINGS

The following detailed description is made with reference to the invention as disclosed. Preferred implementations are described to illustrate the invention disclosed, not to limit its scope, which is defined by the claims. Those of ordinary skill in the art will recognize a variety of equivalent variations on the description.

Thus, for example, it will be appreciated by those of ordinary skill in the art that the diagrams, schematics, illustrations, and the like represent conceptual views or processes illustrating systems and methods embodying this invention.

The Screwdriver multitool stands out from traditional screwdrivers in terms of convenience and functionality. Unlike many screwdrivers that come with only a limited selection of screw-bits, or others that require users to carry both the screwdriver and screw-bits in separate cases, this tool offers a comprehensive solution. It provides complete screw-bit sets, allowing users to carry all the necessary tools in one compact and all-in-one multitool. This not only streamlines tool organization but also ensures that users have a wide range of screw-bits readily available for various applications, making it an ideal choice for those who value efficiency and versatility in their toolkit.

A multipurpose screwdriver and bit holder tool, comprising a screw bit holder comprising an outer housing defining a longitudinal axis having channels on the outer periphery for storage of various screw bits, ensuring secure retention and easy accessibility;
an internal housing for storing one or more double sided screw-bits; a Slide-in and slide-out screw bit design in the channels, allowing for quick tool interchange, wherein the screw-bits retained in place with a magnet placed inside; an wrench cap equipped with a magnetic slide-lock mechanism for secure screw bit in place in storage and prevent the screw bits from slipping off or out; an ergonomic anti-slip handle, ensuring a comfortable grip and convenient tool access.

The channels are in screwdriver and bit holder tool is in the shape of hex molded cutout, which serve as a screw bit body for precise fitting. So, the screw-bits didn't get loose clockwise and counter-clockwise.

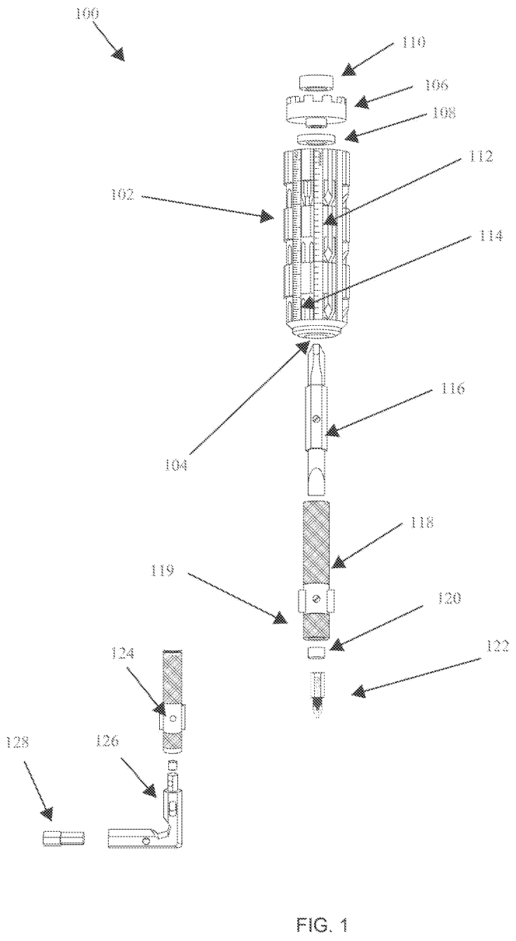

FIG. 1 illustrates the expanded or exploded view of the screwdriver and bit holder tool with an extension and attachment, in accordance with the embodiment of the current invention.

FIG. 1 illustrates the screwdriver and bit holder tool (100) having various components of the screwdriver, holding or storing screw bits in outer housing (102) and screwdriver handle. There is an internal housing (104) for storing double sided screw bits 5/16″, PH3+SLB. There is also a detent ball on the double-sided screw bits 5/16″

The present invention relates to the screwdriver and bit holder tool (100) to store multiple screwdriver bits in order, in the dedicated housing or slots or channels. The outer housing also act as a driver for screw bits.

Many of us have experienced the frustration of misplacing or losing screw-bits during or after a repair task. It's a common issue that can disrupt the workflow and cause inconvenience. However, with this screwdriver and bit holder tool (100), the screw-bits won't even touch the ground; they remain securely housed in their dedicated compartments. This means one can work confidently, knowing that the tools are always within reach and won't get lost. It not only streamlines the repair process but also adds a level of convenience that sets the screwdriver and bit holder tool (100) apart from traditional tools.

In another embodiment, the screwdriver and bit holder tool (100) has different housing or slots or channels of different length or widths to store different sizes screwdriver bits in the periphery or in the outer housing (102).

These screwdriver bits can be easily removed and can be interchanged to the screwdriver handle.

The handle is an ergonomic anti-slip handle with dedicated storage for all your tools, all visible and accessible in seconds.

The screwdriver handle consists of a magnet (108) on the top of the screwdriver to hold secure the screw bits in place, a cap made of metal with integrated spoke wrench (106) and the bubble leveler (110). The screwdriver and bit holder tool (100) store screwdriver bits in their dedicated housing, which is the outer housing, or we can say the handle of the screwdriver and bit holder tool (100). There is another magnet (120), which is integrated in the double-ended hex socket that holds the screw bit(s), when ready to be used or when in use.

Both the magnets in the screwdriver and bit holder tool (100) handle and double ended hex socket (118) remain inside and not visible to the user. The magnet (108) also keep the cap in place because the cap is made of metal. The magnet (108) is sandwiched between the cap and the housing.

One or more double-ended screw-bits are provided with the detent ball (124), which goes in one side ( 5/16″) of the double-ended hex socket that can be placed inside if not being used or outside the screwdriver handle if it is use. The screwdriver having channels ¾″ (6.35 mm) width which are formed on the outer periphery can store different size screw-bits.

The screw bits are configured to slide into and slide out of the channels formed on the outer housing, for storage and for use respectively.

The screwdriver and screw bits are coated with 18K gold or platinum or titanium other precious metal with beveled edges make this screwdriver and bit holder tool (100) one of a kind.

The screwdriver and bit holder tool (100) is configured to be packed with 40 plus essential features and is useful for anyone looking to own an ALL-IN-ONE multitool that can be used in everyday repair.

In another embodiment, the screwdriver further consists of a file tool on the double-sided hex socket to be used for filing purposes. The file tool serves to smooth sharp edges, making it an ideal addition for individuals seeking perfection in their work. It contributes to achieving a polished and professional result by refining project finishes and eliminating roughness or burrs from edges.

In another embodiment, knurling grip (119) is provided on the double-sided hex socket. It provides resistance while pulling the bits out of the socket.

In another embodiment, the screwdriver further consists of a key lock to hold the screw bit while in use. So, the screw-bits didn't fall off.

The screwdriver and bit holder tool (100) is designed to keep both the tool and hand dry to prevent bacterial build up by letting the warm air circulate and escape between its grooves while it's in use.

In another embodiment, screwdriver and bit holder tool (100) consists of rulers (112,114) on the edges that can be used to measure both inches and metric unit to give you precise measurement. The inclusion of two rulers in both inches and metric units is a valuable feature in the screwdriver and bit holder tool (100). These rulers offer a practical and versatile function that can be appreciated in various situations where precise measurements are required.

Whether you're working on DIY projects, or making quick measurements, or tackling tasks that demand accuracy, having access to both inches and metric rulers within the screwdriver and bit holder tool (100) ensures that you can handle a wide range of measuring needs effectively and conveniently.

The rulers on a screwdriver and bit holder tool (100) enhances the overall utility of the tool, making it even more versatile and indispensable for users in various fields and scenarios.

The screwdriver bit holder made of the highest quality stainless steel 17-4 PH and has a valuable combination of high strength, good corrosion resistance, and hardness.

In another embodiment, screwdriver and bit holder tool (100) includes a high precision circular bubble leveler (110) that is capable of leveling both horizontal and vertical surfaces. This bubble leveler provides a visual guide that helps you precisely center the position of the screwdriver, ensuring that the screw bit aligns perfectly with the screw.

By facilitating accurate alignment, this reduces the risk of damaging the screw, making your repair tasks more efficient and preventing screw stripping. This advanced bubble leveler enhances the versatility of the tool, ensuring that users can achieve precise leveling for a wide range of applications, whether they are working on horizontal installations or vertical alignments.

The bubble leveler (110) is a valuable addition to the screwdriver and bit holder tool (100) which elevates this multi-tool functionality, making it suitable for tasks that demand top-notch level precision in achieving level surfaces.

The screwdriver and bit holder tool (100) further comprises an attachment (126), which provides the length and extra torque to the tool. It further offers a remarkable transformation that caters to a variety of repair needs. The user can easily convert it into a standard ¼″ setup, ideal for most everyday repairs, whether for personal hobbies or professional work. This configuration ensures you have a compact and versatile tool at your disposal. Additionally, for larger and longer screw-bits, the user has the option to transform the multitool into a robust 5/16″ screwdriver, equipped with Philips and Flat head bits. This enhanced setup is perfect for tackling more substantial tasks and bigger jobs with ease, providing the flexibility and adaptability you need for diverse repair and maintenance projects.

Different bits which are included in the screwdriver bit holder are: 27 different size screw-bits ¼″ and the double ended 5/16″ Phillips and flat head. A file tool that can be used to smooth sharp edges for those of us who are looking for perfection. This screwdriver and bit holder tool (100) having a spoke wrench (106) in all the sizes available so that no matter what type of spoke wheels, you will be covered. Also, included a DT Swiss (T20) for use on Tricon wheels.

There is a double end-point hex socket (118) with having earth magnet (120) and detent ball (124), which can easily be transformed into a standard or a full set-up to adapt to any job you might have. The screwdriver and bit holder tool (100) is meticulously engineered to offer users the utmost flexibility in how they choose to utilize the tool to suit the precise needs of their repairs.

With its double-ended hex sockets featuring both ¼″ and 5/16″ configurations, this screwdriver and bit holder tool (100) adapts to user requirements, providing the right tool for the job exactly when they need it. Whether the user is working on intricate tasks or handling more substantial repairs, the screwdriver and bit holder tool (100) ensures that the users have the appropriate tool at their disposal, offering unmatched versatility and convenience for a wide range of maintenance and repair scenarios.

The screwdriver has integrated earth magnets, which keeps the screw-bits in the outer housing, where you want them to be at all times.

The screwdriver is designed to keep both the tool and your hand dry to prevent bacterial build up by letting the warm air circulate and escape between its grooves while it's in use. The user experiences a seamless anti-slip comfort handle that enables adept use of all the screw-bits as grip leverage. This handle design facilitates an air circulation process through the tool grooves, allowing air to pass through both ends, ensuring both the tool and your hand stay dry. The attachment (126) configured to have hex 8 socket and can be used with an extension (128).

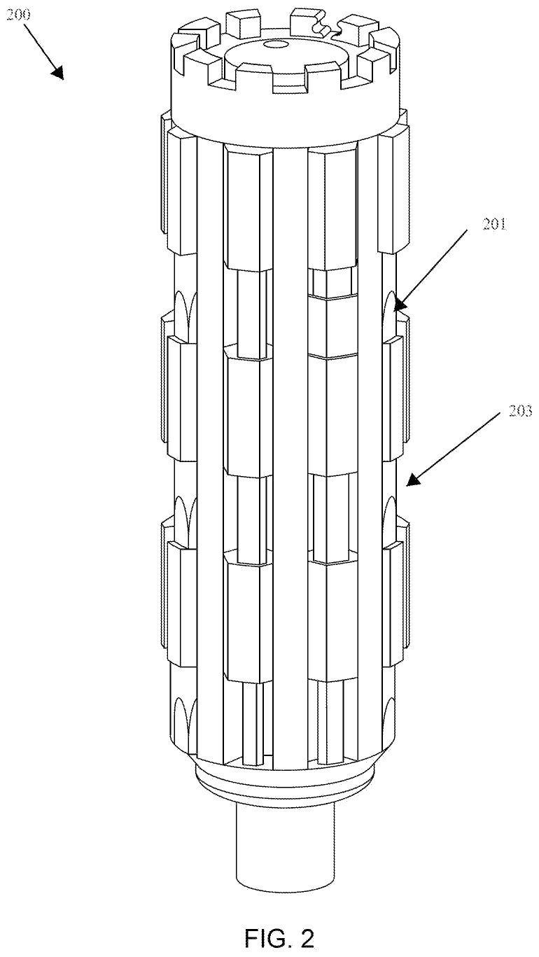

FIG. 2 illustrates FIG. 2 illustrates a view of the screwdriver and bit holder tool (200) outer housing without attachment or extension, in accordance with the embodiment of the current invention. FIG. 2 further illustrates various channels (201, 203) of different length and sizes to secure screw-bits of different sizes.

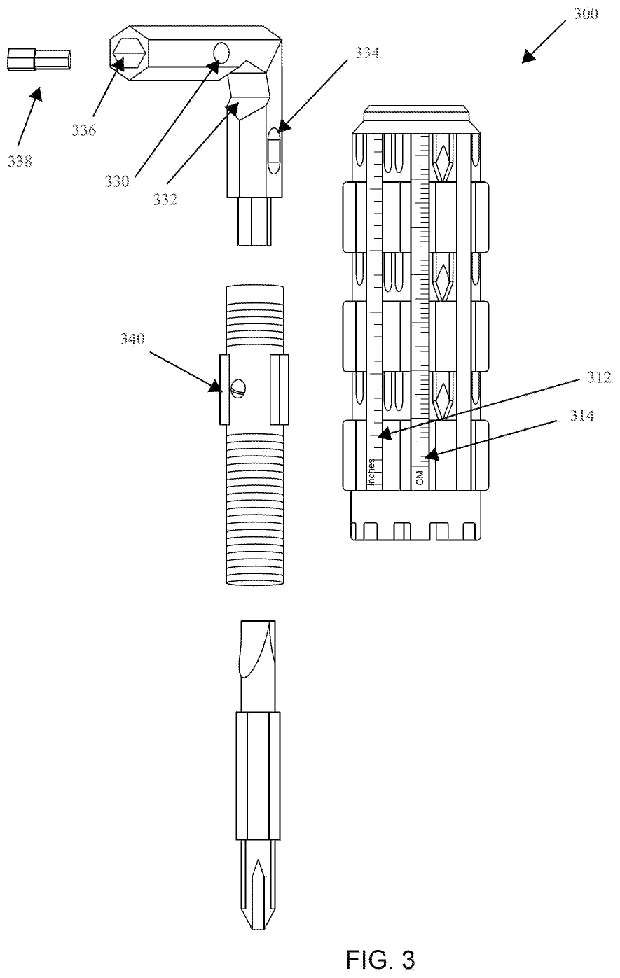

FIG. 3 illustrates the closed view of the screwdriver and bit holder tool with attachment, in accordance with the embodiment of the current invention. FIG. 3 further illustrates the screwdriver and bit holder tool (300) with an attachment (126). The attachment itself is a tool or act as a standalone tool or we can say a combination of tools including a wire bending tool (330), Hex Socket ¾″ (336), wrench tool (332), Hex connector (338) and Wingnut tool (334).

FIG. 3 further illustrates the rulers (312, 314) in Inch and metric units on the outer housing of the screwdriver and bit holder tool.

FIG. 3 further comprises hex Socket 5/16 having a key lock (340), detent ball and a file tool for smoothening purposes.

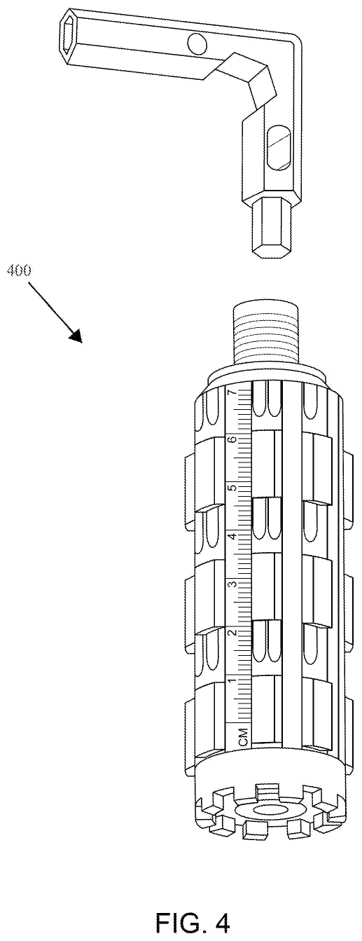

FIG. 4 illustrates the compact view of the screwdriver and bit holder tool with attachment, in accordance with the embodiment of the current invention. The compact view illustrates the use of the attachment with the screwdriver and bit holder tool (400) having screw-bits in the outer housing.

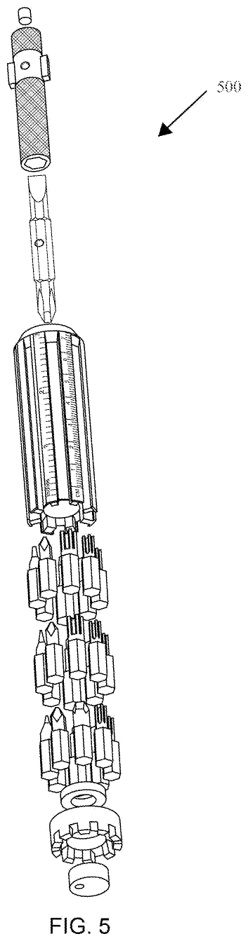

FIG. 5 illustrates another exploded view of the screwdriver and bit holder tool in accordance with the embodiment of the current invention. FIG. 5 illustrates the exploded view, where all the screw-bits are aligned with the channels formed on the outer housing and other components such as magnet, bubble leveler and hex socket cap is aligned with the housing of the screwdriver and bit holder tool.

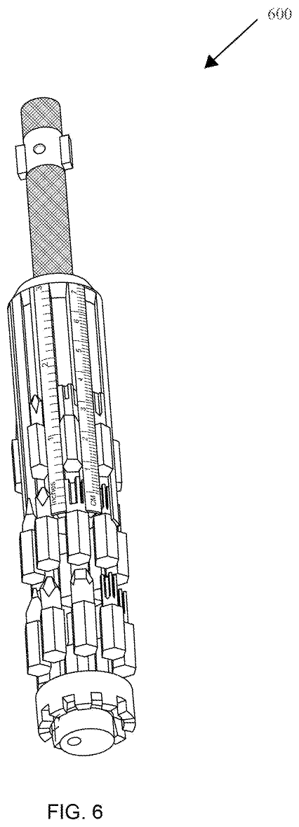

FIG. 6 illustrates an interim assembly view of the screwdriver and bit holder tool, in accordance with the embodiment of the current invention.

FIG. 6 illustrates, where some of the screw-bits and other components are arranged in the outer housing of screwdriver and bit holder tool (600).

The proposed screwdriver and bit holder tool is a child proof device. A wrench cap attaches to the magnet firmly and with its slide-lock design for preventing pulling off and sliding out. This not only secures the screw-bits in place effectively and also offers child safety feature, that no child can open it.

This ensures that the Screw bits in screwdriver and bit holder tool remains versatile by accommodating a range of spoke wrench sizes. This combination of tools, along with the additional spoke wrenches, further establishes the tool as a convenient and comprehensive tool for everyday repairs and maintenance.

A slide-lock design of the cap complements the magnetic force. It may involve a mechanism where the cap slides into place over the housing. Once it reaches the fully locked position, the magnetic force keeps it securely closed. This slide-lock mechanism ensures that the screw-bits are not accidentally released from their housings.

An additional feature of the magnetic slide-lock design is that it provides a level of child safety. It's designed in a way that makes it challenging for children to open the cap easily. This is crucial for preventing accidents or mishaps, especially in households where there may be curious children. The magnetic attraction and slide-lock mechanism create a barrier that makes it difficult for children to access the screw-bits inside the housing. While the magnetic slide-lock design serves as a child safety feature, it is also designed to be user-friendly for adults. The adults can easily and intentionally open the cap when needed. This design feature ensures that adults can access the screw-bits quickly and without much effort, making the tool convenient for its intended users.

The screwdriver and bit holder tool not only provides an extensive set of screw bits but also a comprehensive selection of spoke wrenches in all available sizes, including DT Swiss Tricon (T20), 3.00 mm, 3.23 mm, 3.30 mm, 3.45 mm, 3.75 mm, 3.96 mm, 4.40 mm, and 5.00 mm. This enhances the versatility of the tool, making it an all-in-one solution for various repair and maintenance tasks, particularly those related to bicycles and similar equipment.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention.

This versatile multitool is a comprehensive solution for various tasks, featuring a dedicated screw bit holder with secure and easily accessible storage, a spoke wrench storage adaptable for bicycle and equipment maintenance, double-ended hex sockets for flexible fastening scenarios, an integrated bubble level for precise leveling, an attachment and extension for accessing hard-to-reach areas, and a wrench cap with a magnetic slide-lock mechanism for secure screw bit storage. The ergonomic anti-slip handle ensures a comfortable grip and provides integrated magnets for the secure storage of all tools, including screw bits, spoke wrenches, bubble level, and double-ended hex sockets, which are readily interchangeable through a convenient slide-in and slide-out design. Additionally, the multitool's 18 Karat gold coating with beveled edges enhances its visual appeal, while the wrench cap incorporates a child safety feature to prevent young children from accessing the screw bits, further enhancing the overall user experience.

The screwdriver and bit holder tool is a versatile tool designed for various screwing and fastening needs. It offers a comprehensive set of screw bits that can be carried conveniently all in one tool. Some of the features of the Screw bit driver holder are as mentioned below:

Complete Screw-Bit Set: Screw bit driver holder includes a wide range of screw bits, all of which are conveniently stored in one tool. These screw bits come in two different sizes for compatibility with different screw heads:

¼″ Screw Bits: These include H2, H2.5, H3, H4, H5, H6, SL4, SL5, SL6, SL8, PH0, PH1, PH2, PH3, SQ1, SQ2, SQ3, T10, T15, T20, T25, T27, T30, T35, and T40.

5/16″ Double-Sided Screw-Bit: Phillips and flathead screw bits, offering versatility for various applications.

Double-Ended Screw-Bit 3/16″ PH3 & SL8: This is a specialized screw bit that offers convenience and versatility. It includes both a Phillips (PH3) and a flathead (SL8) on the same bit, making it ideal for various screw types. An integrated detent ball ensures a secure fit when using this double-ended screw bit.

Solid Screw-Bits: One of the key features of Screw bit driver holder is the reliability of its screw bits. These bits are designed to be solid and durable, reducing the likelihood of breakage during use. This durability is especially important for heavy-duty repair and fastening tasks.

Reliable Phillips and Flat Head: The inclusion of reliable Phillips and flathead screw bits ensures that you have the right tools for common screw types. These screw bits are ideal for tasks that require a secure and stable fit, making it easier to tighten or loosen screws effectively.

Screw bit driver multitool is the ultimate tool that simplifies a wide range of tasks, making it the ideal companion for every aspect of your life. Whether a DIY enthusiast, an outdoor adventurer, a photography buff, or a professional, this versatile tool offers a comprehensive solution for various applications. With its secure tool storage, ergonomic design, and a wide selection of screw bits, the multitool streamlines everyday repair and maintenance, ensuring the user is always prepared for any situation. Some of the applications are mentioned below:

General Repairs and Maintenance: This tool can be used for tightening or loosening screws in household items, furniture, and appliances. It's perfect for everyday DIY projects, ensuring convenience and efficiency.

Bicycle Maintenance: Cyclists, whether you ride road bikes, fat bikes, mountain bikes, or BMX bikes, will appreciate the tool for its compatibility with various spoke wrench sizes, making bike maintenance a breeze.

Outdoor Adventures: Outdoor enthusiasts can rely on the tool for quick fixes and adjustments to camping equipment, ensuring safety and convenience during adventures. Snowboarders, skiers, and outdoor enthusiasts can rely on the tool for quick equipment adjustments and repairs, ensuring safety and readiness for their next adventure.

Auto Repairs: While not a full automotive toolkit, this tool is handy for minor auto repairs and maintenance, keeping you prepared on the road.

Household Assemblies: Whether you're assembling furniture, shelves, or fixtures, the tool simplifies the process. Its integrated bubble level ensures precise installations.

Electronics: For electronics enthusiasts and professionals, the tool is perfect for opening electronic devices, ensuring efficient and precise repairs.

Hobbies and Crafts: Crafters and hobbyists benefit from the tools for woodworking, model assembly, and a wide range of projects.

Emergency Repairs: In emergency situations, this compact multitool can be a lifesaver, allowing you to address unexpected issues at home or on the go.

Professional Use: Professionals in construction, woodworking, maintenance, and various fields find the tool is indispensable for its adaptability and convenience in handling screws and fasteners.

Photography: For photographers using DSLR, mirrorless, or action cameras, this ensures quick and precise attachment, detachment, adjustment, or tightening of camera accessories.

Electric Skateboards: As electric skateboards gain popularity, the multi tool ensures the safety and longevity of your skateboard by checking and tightening all hex screws after each ride.

Electric Scooters: With the increasing sales of electric scooters worldwide, having the multi tool is crucial for future repairs, eliminating the need to borrow or rely on friends for extra hex bits during scooter maintenance.

Electricians: Electricians facing emergency calls during off-hours without access to their dedicated toolbox can depend on the multi tool as their Everyday Carry (EDC) multitool, offering quick access to essential tools for those unexpected electrical repairs.

Automotive Repairs: The multitool proves its worth with its extensive selection of screw bits, making it incredibly useful for a wide range of car repairs, whether you're making minor adjustments or need to tighten components.

Fitness Equipment: Fitness enthusiasts often require fitness equipment maintenance, and the multitool ensures that the users have the right tool for the job, keeping their fitness equipment secure and stable.

It is thought that the present invention and its advantages will be understood from the foregoing description, and it will be apparent that various changes may be made thereto without departing from the spirit and scope of the invention or sacrificing all of its material advantages, the form hereinbefore described being merely preferred or exemplary embodiment thereof.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

1. A multipurpose screwdriver and bit holder tool, comprising:
a screw bit holder comprising an outer housing defining a longitudinal axis having channels on the outer periphery for storage of various screw bits, ensuring secure retention and easy accessibility;
an internal housing for storing one or more double sided screw-bits;
a slide-in and slide-out screw bit design in the channels, allowing for quick tool interchange, wherein the screw-bits retained in place with a magnet placed inside;
a wrench cap equipped with a magnetic slide-lock mechanism for secure screw bit in place in storage and prevent the screw bits from slipping off or out;
an ergonomic anti-slip handle, ensuring a comfortable grip and convenient tool access.

2. The multipurpose screwdriver and bit holder tool of claim 1, wherein the channels are in the shape of hex moulded cutout, which serve as a screw bit body for precise fitting.

3. The multipurpose screwdriver and bit holder tool of claim 1, wherein the spoke wrench storage includes compatibility with a range of spoke wrench sizes, offering an adaptable solution for various maintenance needs related to bicycles and equipment.

4. The multipurpose screwdriver and bit holder tool of claim 1, further comprising a concealed magnet integrated within the handle for securely retaining the screw bits and prevent the screw bits from falling off enhancing the overall user experience.

5. The multipurpose screwdriver and bit holder tool of claim 1, further including an 18 Karat gold or titanium coating with bevelled edges, enhancing its visual appeal while maintaining its practicality and versatility.

6. The multipurpose screwdriver and bit holder tool of claim 1, wherein the wrench cap attaches to the magnet with the magnetic slide-lock mechanism includes a child safety feature that deters young children from accessing the screw bits, wherein the magnet is placed in the top of the housing.

7. The multipurpose screwdriver and bit holder tool of claim 1, with the screw bits being readily interchangeable, allowing users to quickly slide them in and out of their dedicated housings or slots.

8. The multipurpose screwdriver and bit holder tool of claim 1, wherein the ergonomic anti-slip handle complete with integrated magnets, ensures the secure storage of screw bits, spoke wrenches, bubble level, and double-ended hex sockets, all of which are easily accessible and visible to the user.

9. The multipurpose screwdriver and bit holder tool of claim 1, further comprising two rulers, one in inches and one in metric units, providing users with versatile and precise measuring capabilities for various tasks, thereby enhancing the tool's functionality and practicality.

10. The multipurpose screwdriver and bit holder tool of claim 1, wherein the anti-slip comfort handle is designed to facilitate air circulation through tool grooves, ensuring both the tool and the user's hand remain dry during use, wherein the grooves also act as grip slip resistant.

11. The multipurpose screwdriver and bit holder tool of claim 1, wherein the spoke wrench storage for addressing maintenance tasks.

12. The multipurpose screwdriver and bit holder tool of claim 1, wherein the double-ended hex sockets for flexible use in a variety of fastening scenarios.

13. The multipurpose screwdriver and bit holder tool of claim 1, wherein the integrated bubble level to provide precision in levelling tasks.

14. The multipurpose screwdriver and bit holder tool of claim 1, wherein an attachment is for extending the length of hex socket for accessing screws located in recessed or hard-to-reach areas.

15. The multipurpose screwdriver and bit holder tool of claim 1, wherein the attachment or attachment to the handle comprises wire-bender tool, N50 magnet, detent ball, Wing-nut tool, 11 mm wrench, ¼″ Hex Socket.
